(19) United States
(12) Patent Application Publication
(10) Pub. No.: US 2003/0109247 A1
(43) Pub. Date: Jun. 12, 2003

(54) System and method for wireless team-oriented voice messages of the invention

(76) Inventors: Tobias Lindgren, Stockholm (SE); Nils Bildt, Djursholm (SE)

Correspondence Address: HARNESS, DICKEY & PIERCE, P.L.C., P.O. BOX 8910, RESTON, VA, 20195, US

(21) Appl. No.: 10/181,354

(22) PCT Filed: Feb. 26, 2001
(86) PCT No.: PCT/SE01/00418

(30) Foreign Application Priority Data
Feb. 24, 2000 (SE) 0000610-6

(51) Int. Cl. H04M 11/10

(52) U.S. Cl. 455/412; 455/566

(57) ABSTRACT

The present invention relates to a mobile telecommunication system for sending and/or listening to voice messages stored in a data base (114). Said system comprises a list of hierarchically arranged selectable alternatives with multiple selectable entries under each of said selectable alternatives in which a user with a mobile phone (102) is presented with a list of predefined subscriber groups, where each subscriber group comprises a plurality of subscribers with tied subscriber's numbers. The invention also relates to a method for sending and/or listening to a voice message.

### FIELD OF THE INVENTION

The present invention relates to a mobile telecommunication system according to claim 1, a method of sending and/or listening to a voice message in a telecommunication system according to claim 14.

### DESCRIPTION OF THE RELATED ART

Because the introduction of the wireless world communication between people has been simplified a lot. However since people do not want to or simply cannot be reached all time different mail message systems have been developed during the years. Said mail message systems can be divided into two groups, a first group being text mail messages and a second group being voice mail messages.

The recipients of a voice mail message or a text mail message, upon accessing his or her voice mail box or text mail box at some convenient time, may listen to or read the message sent by the sender. Voice mail systems and text mail system generally provide the recipient with a number of fixed options such as the ability to save the message, forward the message to another party, and record a reply message to be forwarded to the sender of the original message.

While many voice mail message systems function quite satisfactorily in many applications, the options that are provided to the users are generic. Consequently, a need exists for enhanced voice mail capabilities where users would have better control of what to do with the information contained in a voice message. Moreover present voice message systems are still not sufficiently user-friendly and therefore there is a need to offer enhanced, easier, informative and optionally more personal service.

### SUMMARY OF THE INVENTION

It is an object of the present invention to propose a solution for further user friendly functionality for at least sending and listening to voice mails.

According to the present invention this object is obtained by providing a telecommunication system according to claim 1, and by a method for sending and/or listening to a voice mail in a telecommunication system according to claim 14.

One advantage with the present invention is that subscribers are formed in groups presented as list of hierarchically arranged selectable alternatives on a display for further actions.

Another advantage with a preferred embodiment of the present invention is that further information about the sender of a voice message is displayed on said visual interface such as for example the subscriber's number of the sender and/or the name of the sender of said voice message.

Yet another advantage with the present invention is that the user can scroll up and down through said list of hierarchically arranged selectable alternatives on a display, thereby enabling said user to select an arbitrary voice mail to listen to.

Still another advantage with the present invention is that it enables time savings for the user when trying to reach a number of subscribers compared to existing methods.

Still another advantage with the present invention is that it enables quick group information sharing.

Still another advantage with the present invention is that it is telephone operator independent.

Still another advantage with the present invention is that it is an effective tool for companies with several groups which are mobile and need to communicate with each other.

The present invention will become more fully understood from the detailed description given herein below and the accompanying drawings which are given by way of illustration only, and thus are not limitative of the present invention.

### BRIEF DESCRIPTION OF THE DRAWINGS

FIG. 1 shows a system overview of one embodiment of the present invention.

FIG. 2a shows a simplified course of event diagram when listening to a received voice message according to the present invention.

FIG. 2b shows schematically what a user will experience in the example as described in connection with FIG. 2a.

FIG. 3a shows a simplified course of event diagram when sending a voice message according to the present invention.

FIG. 3b shows schematically what a user will experience in the example as described in connection with FIG. 3a.

FIG. 4a shows a simplified course of event diagram when initiating a group call according to a preferred embodiment of the present invention.

FIG. 4b shows schematically what a user will experience in the example as described in connection with FIG. 4a.

### DETAILED DESCRIPTION

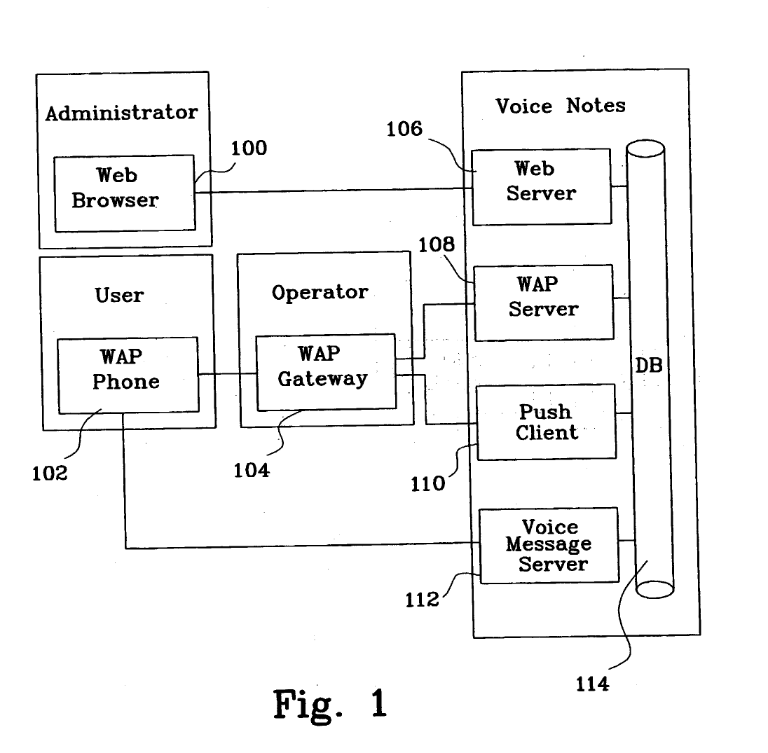

Referring now to FIG. 1, there is shown a system overview of one embodiment of the present invention. The system comprises a Web browser 100, a WAP (Wireless Application Protocol) mobile telephone 102, a WAP Gateway 104, a Web server 106, a WAP server 108, a Push Client 110, a voice message server 112 and a data base 114. The Web browser 100 requests WWW (World Wide Web) contents from the web server 106 using the HTTP (Hypertext Transfer Protocol) protocol over TCP/IP (Transmission Control Protocol/Internet Protocol) and displays the received content to the user on a computer screen.

The Web browser initiates the communication by requesting a web page from the web server 106. In this invention the web browser is used by administrators to administrate users and groups. Examples of existing web browsers 100 are Microsoft Internet Explorer® and Netscape Navigator®. The web server 106 generates HTML (Hypertext Markup Language) pages that can be viewed as mentioned above in the web browser 100. The functionality provided for the above mentioned administrators will at least be to add a group of subscribers to a list of groups, remove a group from the list of groups, add a subscriber to a list of subscribers, remove a subscriber from the list of subscribers and modify user settings. Said user settings can for example be how said information should be displayed on the monitor for the user. The information about users and groups are stored in the data base 114. The web server 106 generates the HTML pages dynamically by reading data from the data base 114 and inserting the data into the HTML pages. When modifying data through the web browser 100, the web server 106 writes data to the data base 114.

The data base 114 holds all information about the users, groups and voice messages as well as the digitized voice messages. The data base 114 is also used for communication between the voice message server 112 and the WAP server 108. The database 114 provides necessary functionality through stored procedures. The WAP server 108 generates WML (Wireless Markup Language) pages that can be viewed in a WAP browser. WAP browsers exist for mobile phones 102 but also PDA:s (Personal Digital Assistant) and computers. The WAP browser provides at least the functionality to view message information in different ways for example in groups of users, per user, chronologically in time or alphabetical order, listen to voice messages and recording and sending voice messages. Optionally the WAP browser provides the functionality to set up a call to the users in one group. The groups presented to the user are preferably only those groups to which he belongs. Alternatively one or a plurality of other groups are presented for the user to which he does not belong, but could send or listen to voice messages and optionally set up a group call.

As mentioned above is the information about the voice messages stored in the data base 114. The WAP server 108 generates WML decks dynamically by reading data from the data base 114 and inserting the data into the WML code. The WML decks being a collection of WML cards, where a WML card is a single WML unit of navigation and user interface. Such a WML card may contain information to be presented to the user, instruction for gathering user input, etc. The WML code contains options to call the voice message server 112 for listening and recording voice messages. When recording voice messages and modifying data through the WAP browser, the WAP server 108 writes data to the database 114.

The WAP mobile telephone 102 communicates with the WAP server 108 via the WAP gateway 104. The WAP mobile telephone 102 communicates with the gateway 104 using WAP protocol with SMS as bearer. Normally, the WAP telephone 102 initiates the communication by requesting a WML deck. The exception is when the push client 110 sends a notification to the WAP telephone 102. The WAP gateway 104 communicates with the WAP server 108 using HTTP protocol over TCP/IP. The WAP gateway initiates the communication by requesting a WML deck. The WAP gateway 104 translates requests from the WAP protocol stack to the WWW protocol stack (HTTP and TCP/IP). It also encodes WML content received from the WAP server 108 via HTTP and TCP/IP into a compiled, more compact form, which is sent to the WAP telephones 102 using the WAP protocol.

The WAP telephone 102 requests WML decks, i.e. WAP content, from the WAP servers 108 using the WAP protocol. Before reaching the WAP servers 108, the WAP requests are translated as mentioned above in the WAP gateway 104. When receiving the response from the WAP server 108, via the WAP gateway 104, the WAP telephone 102 displays the WAP content in the phone display. The visual interface specified by the WAP content lets the user navigate or scroll through the WML cards reading information and entering information.

The WAP gate way 104 communicates with the push client 110 using HTTP protocol over TCP/IP. The push client 110 initiates the communication when a new message has arrived to the user. The push client 110 is responsible for notifying the WAP telephones 102 of new messages. This is done by regularly polling for new messages in the database 114. If one or more new messages has been stored in the data base 114, the push client notifies the WAP telephone(s) 102. This is done via the push access protocol in WAP.

The WAP telephone 102 communicates with the voice message server 112 using circuit switched call (i.e. a normal telephone voice call). The WAP telephone 102 initiates the communication by dialling the number to the voice message server 112. The voice message server 112 records and plays voice messages. When the WAP telephone 102 calls the voice message server's 112 telephone number, the voice message server 112 answers the call and gets the MSISDN number of the telephone 102. The voice message server 112 checks the database 114 for information on what the user wants to do. This information has been written to the database 114 by the WAP server 108 which has received the information from the WAP telephone 102 via the WAP protocol.

If the user has chosen to listen to a received voice message, then that message is played to the user. If the user has chosen to record and send a voice message then a message is recorded and written to the database 114. Additional information about the message is also written to the database 114 such as the time the message was recorded and the recipients to the message. Part of this information, e.g. recipient information, has been supplied by the WAP telephone 102 to the WAP server 108.

The database 114 communicate with the web server 106, WAP server 108, push client 110 and voice message server 112 using ODBC (Open Data Base Connectivity), either on the same computer or over a LAN (Local Area Network). The communication is initiated by the system component accessing the database 114, i.e. said web server 106 or the WAP server 108 or the push client 110 or the voice message server 112.

The WAP and web servers 108, 106 can be implemented using Microsoft® internet information server. The voice message server 112 can be implemented using RTK (Real-Time-Kernel) module and IVR (Inter Voice Response) module in the CTS Telecom server from Computer & Telephony Systems AB. The push client 110 can be implemented using Microsoft® Visual Basic. The data base 114 can be implemented using Microsoft® SQL server 7.0.

Instead of using WAP for communication with the mobile telephone 102 and displaying information in the mobile telephone display a SIM application Toolkit can be used. For this to work, it requires that the mobile telephone 102 supports SIM Application Toolkit. Instead of using SMS as bearer for the WAP protocol, other bearers can be used. In GSM (Global System for Mobile communication) networks the only possible alternatives currently is Circuit switched data (CSD) and GPRS (General Packet Radio Service). Instead of using WAP protocol to perform the actions by the voice message server 112, e.g. play a specific message or record a message for a certain group these directives can be specified using DTMF (Dual Tone Multi Frequency) signals sent in the circuit switched speech call directly to the voice message server 112. The WAP/WTA function “send DTMF” can be used to send DTMF signals telling the voice message server 112 what to do for instance, the sequence “3487” could specify “record a message for group 487” where the first digit (3) specifies the action, in this case “record a message to a specified group”.

Instead of using the push client 110 which uses the push functionality in the WAP protocol to send notifications about new messages to the mobile phone SMS can be used sending ordinary text to the mobile telephone.

The optional group call is, as mentioned above, initiated by letting the WAP telephone 102 call other phones using WTA functions. Instead this could be implemented by letting the WAP telephone call 102 the voice message server 112. The voice message server 112 then calls the phones of the group members in parallel which decreases the time of the group call setup.

Everything that can be done via the display of the mobile telephone 102 can be done at the visual interface belonging to the web server 106, i.e. via a monitor connected directly or in the same LAN to said web server 106 or via a monitor connected to said web server 106 via internet. Furthermore, the web server 106 could provide extra message handling functionality, for example the message could be moved to different folders (groups) or be sent as an attachment to an E-mail.

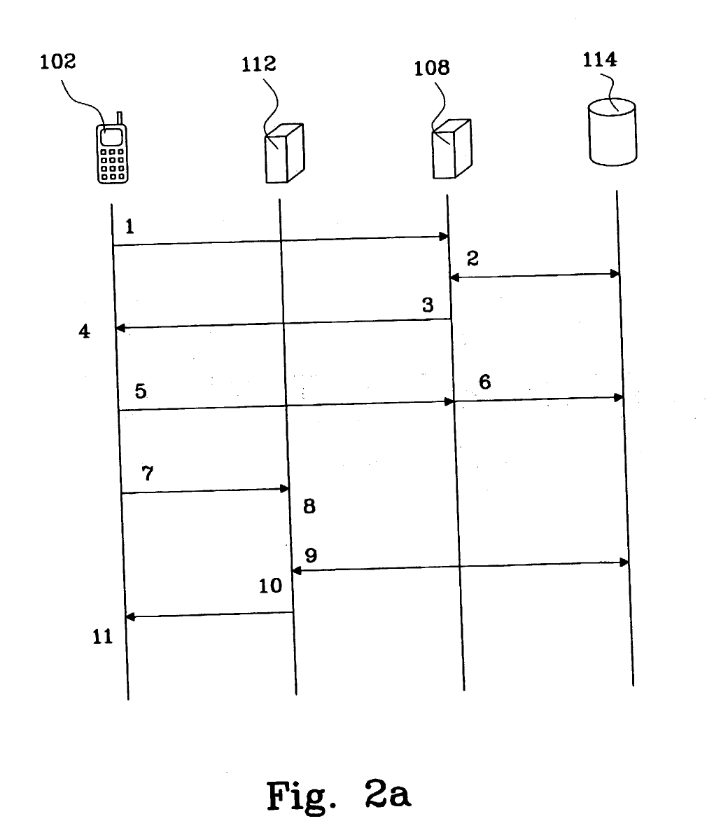

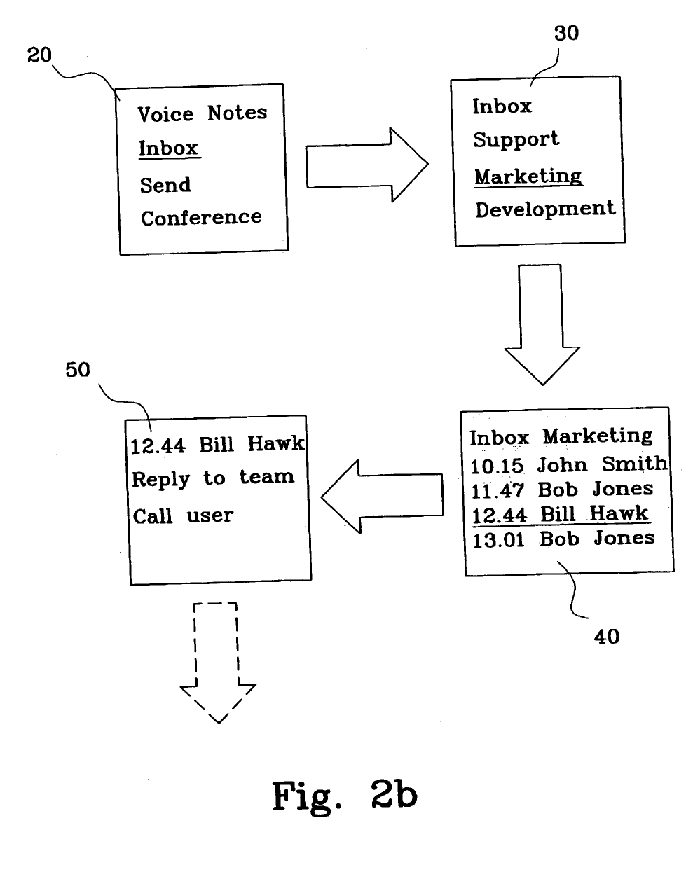

FIG. 2a shows a simplified course of event diagram when listening to a received voice message according to an embodiment of the present invention.

A first event 1 being that the user selects the voice message application in the WAP mobile telephone 102. A WAP request is sent to the WAP server 108 via the WAP gateway.

A second event 2 being that the WAP server 108 reads data from the data base 114 and generates the WML deck with WML cards containing user specific information including information about the voice message in the user's inbox. The WML cards (pages) contain message ID's for all messages in the user's inbox.

A third event being that the generated WML deck is sent to the WAP mobile telephone 102 via the WAP gateway.

A fourth event being that the WML cards is displayed in the WAP telephone 102 and the user navigates trough the WML cards and selects a certain voice message to listen to. Said navigating is performed by scrolling through hierarchically arranged selectable alternatives with multiple selectable entries under each of said selectable alternatives in which a user of said mobile phone 102 is at least presented with said list of predefined subscriber groups. Said scrolling may be accomplished by pressing a key or keys on a keypad arranged on said mobile telephone to read forwards and backwards through the list. Each key press on the key pad may index an increase or a decrease in order of the list. Each group having a plurality of subscribers with tied subscriber's number. Selection of the desired group and actions is then accomplished when said group or action is displayed while scrolling, by ceasing scrolling and activating said choice. The alternative or entry may be activated by pressing a YES button while the associated group or action is being displayed.

A fifth event being that the WAP request containing information which specifies selected action (i.e. listen) and the ID of the selected message is sent to the WAP server via the WAP gateway.

A sixth event being that the WAP server 108 writes this information to the data base 114 including the MSISDN number of the WAP mobile telephone 102. Said MSISDN number is provided by the WAP protocol.

A seventh event being that the WAP mobile telephone 102 calls the voice message server 112. This is done by the WAP WTA (Wireless Telephony Application) function Make Call which sets up an ordinary circuit switched call to the voice message server 112.

An eighth event being that the voice message server 112 answers the call.

A ninth event being that the voice message server 112 reads from the data base 114 which action to perform for the MSISDN number of the calling-in phone. This has previously been written to the data base 114 by the WAP server 108.

A tenth event being that the selected voice message is played by the voice message server 112 and listened to by the user.

An optional eleventh event being that in the WAP mobile telephone 102, the user is presented with a list of alternatives on possible actions on the message. Examples of said actions could be send a voice message to the single subscriber, send a message to the group of subscribers, calling the single subscriber, setting up a group call to a number of subscribers, save voice message, delete message etc.

In FIG. 2b is shown schematically what the user will experience in the above described example in connection with FIG. 2a. The voice message application 20 which in this example is called voice notes presents three alternatives to the user namely inbox send and conference. As the previous example described listening to a voice message the user selects the inbox alternative and is presented with the groups the subscriber is a member of 30. These groups being the support, marketing and development groups. The user selects the group marketing and is presented with the voice messages sent to the marketing group 40. The user selects the message from Bill Hawk out of the four alternatives where the other three comes from John Smith, Bob Jones and Bob Jones again. As can be seen are the messages arranged in chronological order of time. The voice message server is now called and the message is played to the user. Possible optional actions on the message is displayed when the message has been listened to 50. These optional actions being reply to team (group) and call user. If the user selects reply to team, a message from the user is recorded and sent to the marketing team. If the user selects call user, an ordinary speech call is set up.

In stead of sending the voice message only to those groups the user is a member of the voice message could alternatively be sent to a group which the user is not a member of. A further alternative is that a message is sent to just one or some of the members of a group.

Setting up the group call could be performed by specifying a date and time and save those data in the data base 114. A notification is sent to the members of the group with information on when the group call will take place. If a calendar is available for the different members in the group a suitable time for said group call may be found automatically by looking into said calendars by a programme stored for example in the data base 114.

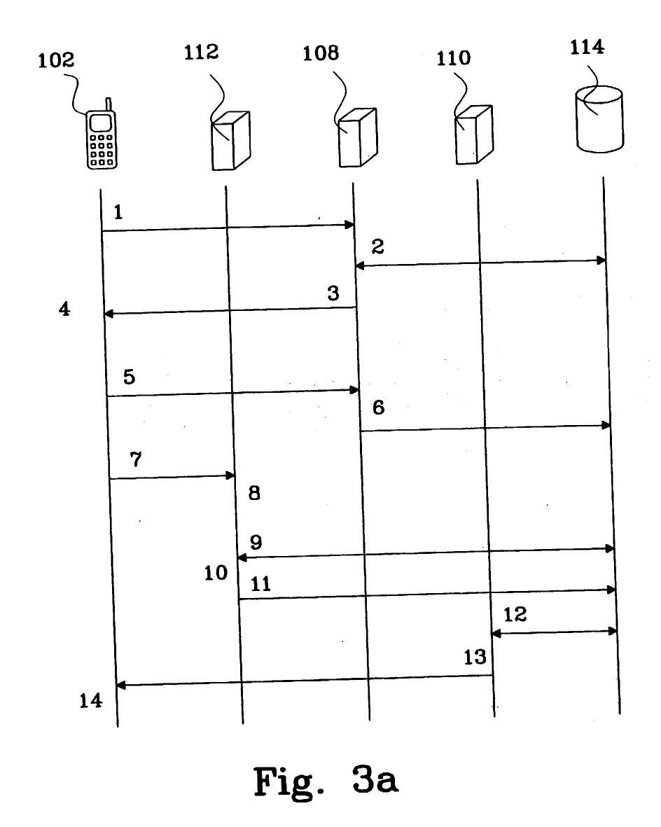

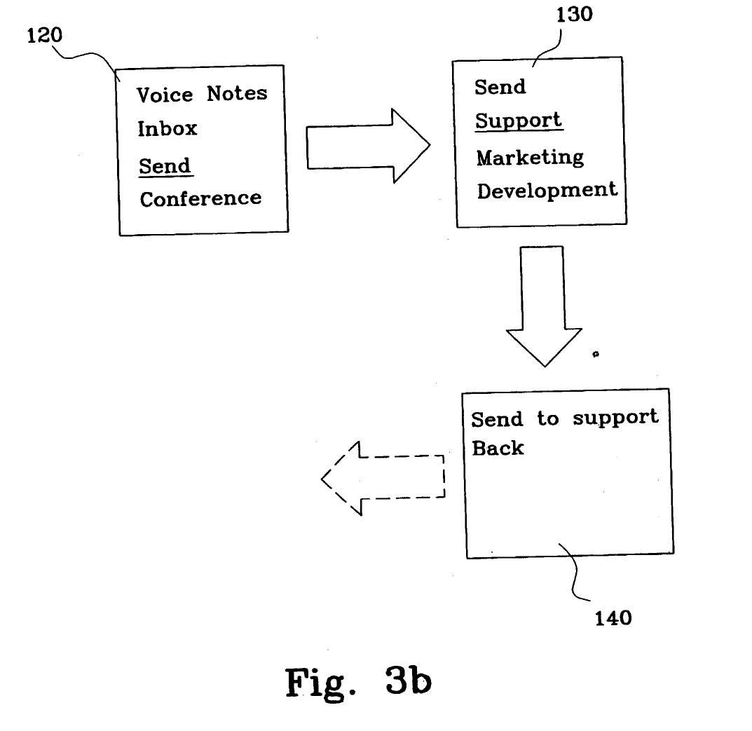

FIG. 3a shows a simplified course of event diagram when sending a voice message according to an embodiment of the present invention.

A first event 1 being that the user selects the voice message application in the WAP mobile telephone 102. A WAP request is sent to the WAP server 108 via the WAP gateway.

A second event 2 being that the WAP server 108 reads data from the data base 114 and generates the WML deck with WML cards containing user specific information including the group names and ID's for the groups the user is a member of.

A third event being that the generated WML deck is sent to the WAP mobile telephone 102 via the WAP gateway.

A fourth event being that the WML cards is displayed in the WAP telephone 102 and the user navigates trough the WML cards and selects the team he or she wants to send a message to. Said navigating is performed by scrolling through hierarchically arranged selectable alternatives with multiple selectable entries under each of said selectable alternatives in which a user of said mobile phone 102 is at least presented with said list of predefined subscriber groups. Said scrolling may be accomplished by pressing a key or keys on a keypad arranged on said mobile telephone 102 to read forwards and backwards through the list. Each key press on the key pad may index an increase or a decrease in order of the list. Each group having a plurality of subscribers with tied subscriber's number. Selection of the desired group and actions is then accomplished when said group or action is displayed while scrolling, by ceasing scrolling and activating said choice. The alternative or entry may be activated by pressing a YES button while the associated group or action is being displayed.

A fifth event being that the WAP request containing information which specifies selected action (i.e. send voice message) and the ID of the selected group is sent to the WAP server 108 via the WAP gateway.

A sixth event being that the WAP server 108 writes this information to the data base 114 including the MSISDN number of the WAP mobile telephone 102. Said MSISDN number is provided by the WAP protocol.

A seventh event being that the WAP mobile telephone 102 calls the voice message server 112. This is done bythe WAP WTA (Wireless Telephony Application) function Make Call which sets up an ordinary circuit switched call to the voice message server 112.

An eighth event being that the voice message server 112 answers the call.

A ninth event being that the voice message server 112 reads from the data base 114 which action to perform for the MSISDN number of the calling-in phone. This has previously been written to the data base 114 by the WAP server 108. A tenth event being that the voice message server plays a voice prompt: “please record you message. End by pressing 1” The user speaks, press button 1 and the message is recorded by the voice message server 112.

An eleventh event being that the voice message server 112 writes the voice message to the data base 114 as well as the time the message was recorded and the information previously received by the WAP server 108 about the recipient group ID and the sender of the message.

A twelfth event being that the push client 110 checks the data base 114 regularly, e.g. once per hour, and now detects that a new message has arrived. The push client 110 reads the necessary information from the database 114 to get which users should receive the message.

A thirteenth event being that the push client 110 notifies the recipients of the voice message. This is done by using the push access protocol in WAP. The effect of this is that the WAP phone receives data via the WAP protocol which is displayed in the WAP mobile telephone 102.

A fourteenth event being that the user now can listen to the new message or messages. How this can be done was previously described in connection with FIG. 2a and FIG. 2b above.

In FIG. 3b is shown schematically what the user will experience in the above described example in connection with FIG. 3a. The voice message application 120 which in this example is called voice notes presents three alternatives to the user namely inbox send and conference. As the previous example described sending a voice message the user selects the send alternative and is presented with the groups the subscriber is a member of 130. These groups being the support, marketing and development groups. The user selects the group support and the voice message server is now called and the prompt “please record your message. End by pressing 1” is played. The user speaks and the voice message is recorded by the voice message server. The user will be presented with two alternatives after having recorded a voice message namely send to support and back. The user can send the new message by choosing send to support or leave the voice message application by choosing back.

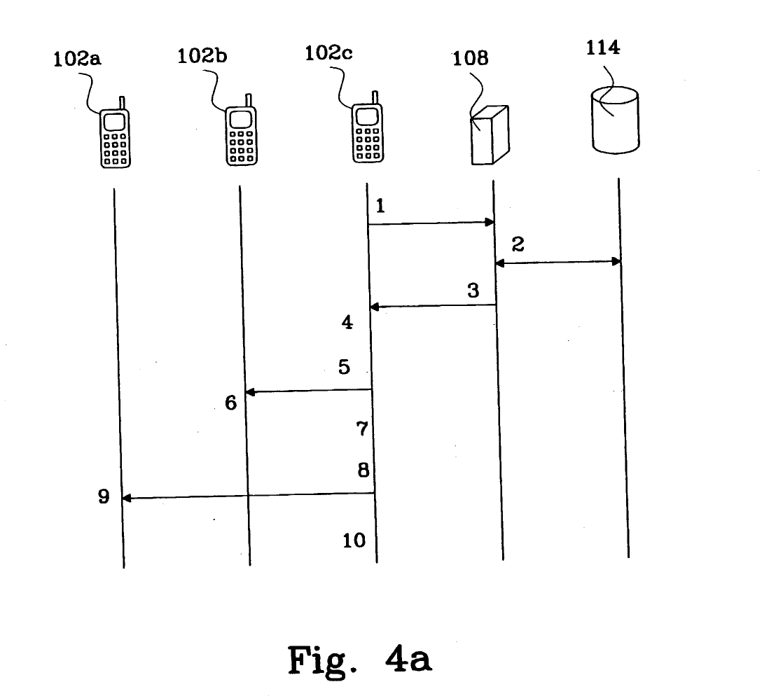

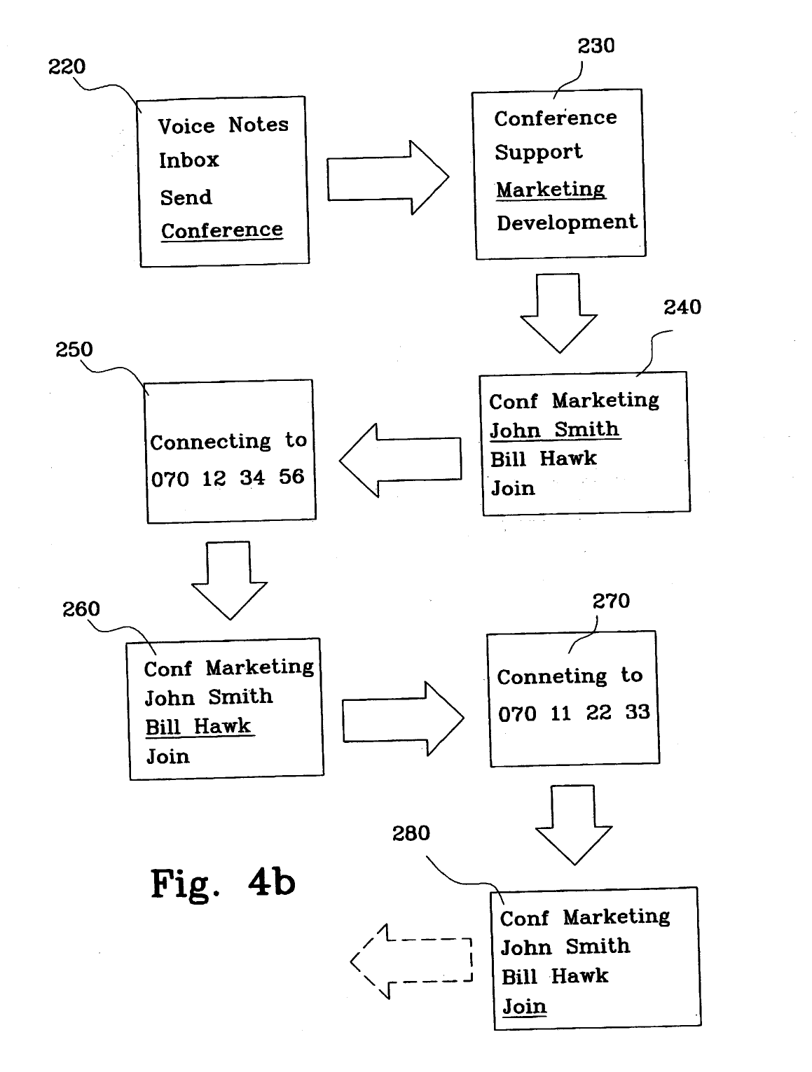

FIG. 4a shows a simplified course of event diagram when initiating a group call according to an embodiment of the present invention.

A first event 1 being that the user selects the voice message application in the WAP mobile telephone 102. A WAP request is sent to the WAP server 108 via the WAP gateway.

A second event 2 being that the WAP server 108 reads data from the data base 114 and generates the WML deck with WML cards containing user specific information including the group names the user is a member of and the subscribers' numbers for the members of said groups.

A third event being that the generated WML deck is sent to the WAP mobile telephone 102a via the WAP gateway.

A fourth event being that the WML cards is displayed in the WAP telephone 102a and the user navigates trough the WML cards and selects that he or she wants to initiate a group call and he or she also selects with which group he wants a group call. Said navigating is performed by scrolling through hierarchically arranged selectable alternatives with multiple selectable entries under each of said selectable alternatives in which a user of said mobile phone 102a is at least presented with said list of predefined subscriber groups. Said scrolling may be accomplished by pressing a key or keys on a keypad arranged on said mobile telephone 102a to read forwards and backwards through the list. Each key press on the key pad may index an increase or a decrease in order of the list. Each group having a plurality of subscribers with tied subscriber's number. Selection of the desired group and actions is then accomplished when said group or action is displayed while scrolling, by ceasing scrolling and activating said choice. The alternative or entry may be activated by pressing a YES button while the associated group or action is being displayed.

A fifth event being that the WAP mobile telephone 102a calls group member number one by using the WTA (Wireless Terminal Application) function setup call.

A sixth event being that the group member number one's telephone 102b rings and he or she answers the call

A seventh event being that the user's WAP mobile telephone 102a puts the call with group member number one on hold. This is done by using the WTA function call hold.

An eighth event being that WAP telephone calls group member number two by using the same procedure as with number one.

A ninth event being that the group member number two's telephone 102c rings and he or she answers the call.

A tenth event being that the user's WAP mobile telephone 102a joins the two calls. This is done by using the WTA function join multiparty. The group call has now been set up.

In FIG. 4b is shown schematically what the user will experience in the above described example in connection with FIG. 4a. The voice message application 220 which in this example is called voice notes presents three alternatives to the user namely inbox send and conference. As the previous example described setting up a group call the user selects the conference alternative and is presented with the groups the subscriber is a member of 230. These groups being the support, marketing and development groups. The user selects the group marketing and is presented with the members of the marketing group 240 namely John Smith, Bill Hawk and A join alternative further described below. The user selects the first member of the group, John Smith and the WAP mobile telephone calls John's mobile telephone 250. When John has answered the user tells him that a group call is being initiated and asks him to wait for a few seconds. The user will be presented with the list of members and now chooses the second member Bill Hawk of the marketing group 260. The WAP mobile telephone calls Bill's telephone 270. When Bill has answered, the user tells him that a group call is being initiated and asks him to wait for a few seconds. The user now selects the join alternative 280 and the WAP telephone joins the two calls into a group call. The group call ends when the user hangs up.

1. A mobile telecommunication system for sending and/or listening to voice messages by using a mobile phone (102) with a display comprising:
said mobile phone (102),
means for communicating and displaying information to the mobile phone (102),
means for sending notification about new messages to the mobile phone (102),
a database (114) having a list of predefined subsriber groups, said subscriber groups comprising a plurality of subscribers with tied subscriber's numbers,
characterised in that said system further comprises
said database (114) being connected to a voice message server (112), to a web server (106), and to said means for communicating and displaying information to the mobile phone,
said web server (106) is used to set up and modify said subscriber groups,
said database (114) further having a list of voice messages,
said mobile phone (102) is arranged to visually display hierarchically arranged selectable alternatives with multiple selectable entries under each of said selectable alternatives in which a user of said mobile phone (102) is at least presented with said list of predefined subscriber groups.

2. The system according to claim 1, wherein the user of said mobile telephone (102) belongs to at least one predefined subscriber group.

3. The system according to claim 1 or 2, wherein said web server (106) is operated through a web browser (100).

4. The system according to any of claim 1-3, wherein said selectable alternatives represent at least
“send a voice message”, and/or
“listen to a voice message”, and
said selectable entries under each of said selectable alternatives represent at least said list of predefined subscriber groups.

5. The system according to claim 4, wherein said selectable alternatives further represent an alternative being
“set up a group call”.

6. The system according to any of claim 1-3, wherein said selectable alternatives represent said list of predefined subscriber groups, and said selectable entries under each of said selectable alternatives represent at least
“send a voice message”, and/or
“listen to a voice message”.

7. The system according to claim 6, wherein said selectable entries further represent an entry being
“set up a group call”.

8. The system according to claim 1, wherein said mobile telephone is a WAP telephone (102), and said means for communicating and displaying information to the mobile phone is a WAP server (108) and a push client (110), said WAP server (108) and said push client (110) communicates with the WAP telephone (102) via a WAP gateway (104).

9. The system according to claim 8, wherein said WAP server (108) and push client (110) communicates with the WAP gateway (104) via internet.

10. The system according to any of claim 1-9, wherein after having listened to a voice message a list of selectable alternatives is displayed on the display.

11. The system according to claim 10, wherein said list of alternatives at least comprises:
“reply to sender”, and/or
“reply to group of subscriber”, and/or
“call user”.

12. The system according to any of the preceding claims, wherein at least the name of the person who sent the voice message and/or the name of the group said message belongs to is displayed on said display.

13. The system according to any of the preceding claims, wherein the user can select to listen to any voice message independently of order in said groups of subscribers.

14. A method for sending and/or listening to voice messages in a telecommunication system according to any of claim 1-13, said method comprising the steps of:
(a) accessing a database (114) having a list of predefined subsriber groups, said subscriber groups comprising a plurality of subscribers with tied subscriber's numbers, by using a mobile phone (102) with a display,
(b) communicating and displaying information to the mobile phone (102),
(c) sending notification about new messages to the mobile phone (102),
characterised in that said method further comprises the steps of:
(d) visualising said list of predefined subscriber groups on the display of the mobile phone (102) in a hierarchically arranged selectable alternatives with multiple selectable entries under each of said selectable alternatives,
(e) selecting one of said predefined subscriber groups,
(f) sending a request to listen to a selected message within said selected subsrciber group or to send a new voice message to a selected subscriber group, the request being sent to the database (114),
(g) connecting said mobile phone (102) to a voice message server (112) connected to said database (114), said selected message being played by the voice message server (112) to which a user of the mobile phone (102) may listen or said new voice message being recorded by the voice message server (112) and stored in a list of voice messages for each subscriber group in said database (114).

15. The method according to claim 14, wherein subscriber group is set up and modified by using a web server (106), being connected to said database (114).

16. The method according to any of claims 14 or 15, wherein said method is selected to operate in two parts, the first part comprising the steps (a)-(f) using a first communication link, and the second part comprising the step (g) using a second communication link.

17. The method according to claim 16, wherein step (b),(c) and (f) the mobile phone (102) communicates with the database (114) via a WAP gateway (104) being a part of said first communication link.

18. The method according to claim 16 or 17, wherein step (g) the mobile phone (102) communicates with said database (114) via an ordinary circuit switched call, as the second communication link, to the voice message server (112).
